(19) United States
(12) Patent Application Publication
(10) Pub. No.: US 2016/0221689 A1
(43) Pub. Date: Aug. 4, 2016

(54) Line Intersect Vehicle Launch and Recovery

(71) Applicant: Christopher Ralph Tridico, Granite Falls, NC (US)

(72) Inventor: Christopher Ralph Tridico, Granite Falls, NC (US)

(21) Appl. No.: 14/952,949

(22) Filed: Nov. 26, 2015

Related U.S. Application Data
(60) Provisional application No. 62/084,615, filed on Nov. 26, 2014.

(51) Int. Cl. B64F 1/04; B64D 3/00; B64D 47/02; B64F 1/08

(52) U.S. Cl. CPC B64F 1/04; B64F 1/08; B64D 3/00; B64D 47/02

(57) ABSTRACT

The present invention is a system which facilitates the launch and recovery of an aircraft or other vehicle by another vehicle or site. This system includes cables, wires or other “lines” that are connected to both the subject vehicle and the launch and recovery platform and facilities to extend, retract and position these lines. When the relative motion of the subject vehicle and launch and recovery platform causes the lines to intersect, the lines are connected to each other by means of a hook, carabiner or similar attachment device resulting in the effective capture of the subject vehicle. One or both of the lines may then be retracted resulting in the recovery of the subject vehicle. Launch is accomplished by extending one or both of the lines and subsequently releasing the attachment device.

### CROSS-REFERENCE TO RELATED APPLICATIONS

This application is a continuation of U.S. provisional patent application No. 62/084,615 filed Nov. 26, 2014.

### STATEMENT REGARDING FEDERALLY SPONSORED RESEARCH OR DEVELOPMENT

Not Applicable

### REFERENCE TO SEQUENCE LISTING

Not Applicable

### TECHNICAL FIELD

The present invention provides a system to facilitate launch and recovery of a subject vehicle by another vehicle or by a fixed site with less space than would typically be required to launch and recover the subject vehicle. The present invention was originally conceived to facilitate launch and recovery of a thrust-borne aircraft by separate launch and recovery aircraft. The same system may be applied where the subject vehicle is an aircraft capable of hovering, a watercraft (surface or submersible), or a ground vehicle. Furthermore, the launch and recovery platform need not be an aircraft, but could be a surface or submersible watercraft, ground vehicle or a fixed ground site or apparatus. Variations of the system may also be applied in a vacuum.

### BACKGROUND ART

The general ability to launch a vehicle from another vehicle and subsequently recover it has been well established by prior art. Furthermore, the usefulness of such ability is readily apparent. A modern water-borne aircraft carrier is an archetypal example of this ability and its applications and utility are well established. A typical modern aircraft carrier employs catapults for aircraft launch and arrester cables and hooks for recovery. Alternative launch and recovery systems have been used and many are still employed with examples including launch assist ramps, barrier assisted recovery and short/vertical take-off and landing capable aircraft.

Beyond the modern aircraft carrier, a wide variety of systems have been applied to launch and recovery vehicles from other vehicles. Launch systems including tow lines, balloons capable of dropping fixed winged aircraft, aircraft dropped from other aircraft in flight, hover capable rotorcraft that drop fixed wing aircraft, and vehicle mounted catapults are just a few examples. Prior art recovery systems have included in-flight capture nets, single lines designed to intersect with and be grappled by rigid component of the subject aircraft, lines dropped from subject aircraft to be grappled by a component of the recovery vehicle, and direct grappling of the subject vehicle by the recovery aircraft.

### Technical Problem and Benefits

The present invention provides the following advantages over prior art:

Provides a large aperture in which recovery can be successfully accomplished without requiring precision guidance on the subject and recovery vehicles or resorting to a recovery apparatus with a large surface area.

Requires minimal physical space on or in the launch/recovery platform.

Enhances subject vehicle stability and control when the subject vehicle is located in a region of turbulent fluid flow near the launch and recovery platform.

Reduces mechanical loading of vehicles due to differences in their velocity vectors during both launch and recovery through the use of lines that may be lengthened or shortened at controlled rates thus providing more gradual changes in velocity.

Enables a single launch and recovery system to be applied across subject vehicles and launch/recovery platforms with vastly different physical attributes and performance characteristics.

Enables retrofit on subject vehicles and launch/recovery platforms with minimal weight and impact on the fluid mechanics of vehicles.

Reduces the danger to both subject vehicles and launch/recovery platforms by initiating launch and recovery while the subject vehicle body remains distant from the launch/recovery platform.

These advantages are enabled by a unique aspect of the present invention in that it uses flexible lines on both the subject vehicle and the launch/recovery platform that are caused to intersect and attach to each other by means of hooks, clamps, carabiners or other attachment device.

### SUMMARY OF THE INVENTION

The present invention is a system which facilitates the launch and recovery of an aircraft or other vehicle (“subject vehicle”) by another vehicle or site (“launch and recovery platform”). This system includes cables, wires or other “lines” that are connected to both the subject vehicle and the launch and recovery platform and facilities to extend, retract and position these lines. When the relative motion of the subject vehicle and launch and recovery platform causes the lines to intersect, the lines are connected to each other by means of a hook, carabiner or similar attachment device resulting in the effective capture of the subject vehicle. One or both of the lines may then be retracted resulting in the recovery of the subject vehicle. Launch is accomplished by extending one or both of the lines and subsequently releasing the attachment device.

### BRIEF DESCRIPTION OF THE DRAWINGS

FIG. 1: Embodiment 1 Launch depicts launching an Unmanned Aerial System subject vehicle from a manned cargo Launch and Recovery Platform using an exemplary embodiment of the present invention.

FIG. 2: Embodiment 1 Recovery depicts recovery of an Unmanned Aerial System subject vehicle into a manned cargo Launch and Recovery Platform using an exemplary embodiment of the present invention.

FIG. 3: Embodiment 1 Recovery Process depicts five steps in the recovery of an Unmanned Aerial System subject vehicle into a manned cargo Launch and Recovery Platform using an exemplary embodiment of the present invention.

### DESCRIPTION OF EMBODIMENTS

### Exemplary Embodiment

### Cargo Aircraft Launch and Recovery of a Small Unmanned Aircraft System

In a first exemplary embodiment of the present invention, an unmanned aircraft system (“UAS”) capable of thrust-borne flight serves as the subject vehicle which is both launched from and retrieved into a larger manned aircraft—the launch and recovery platform (“LRP”).

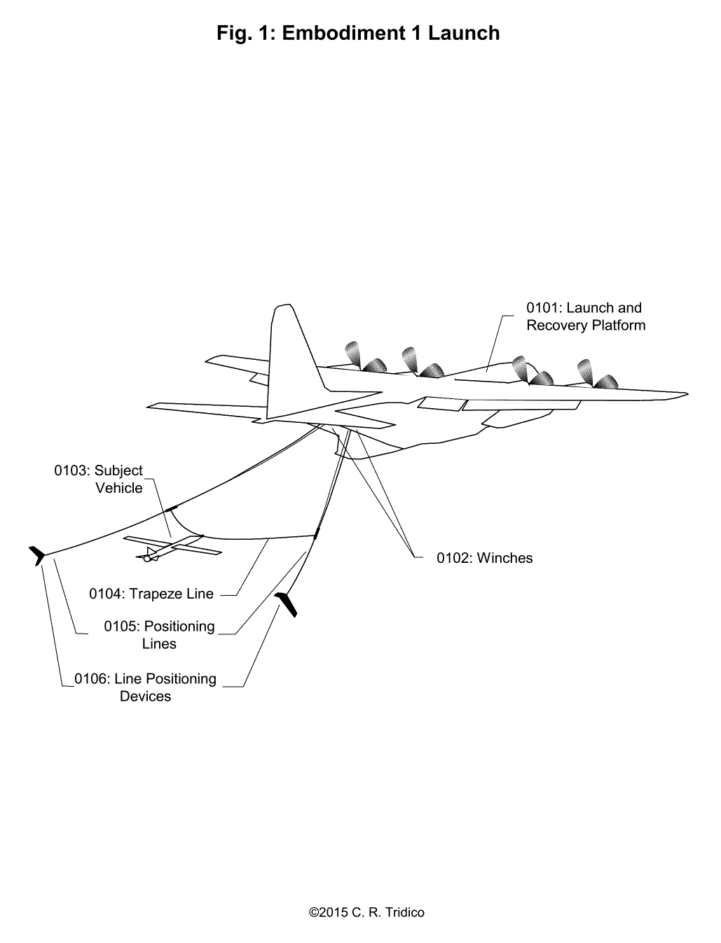

In this embodiment of the present invention, two inverted kites are flown below and aft of the LRP [FIG. 1-0101] to serve as line positioning devices [FIG. 1-0106]. Each kite is towed with a separate high strength, low drag positioning line [FIG. 1-0105]. Each line is spooled by a separate electronic winch [FIG. 1-0102]. A third “trapeze” line spans the distance between the two positioning lines [FIG. 1-0104]. The ends of this trapeze line may traverse the positioning lines through the use of two additional winches. Thus, the trapeze line may be moved between the LRP and the towed kites as needed.

In this exemplary embodiment, the kites passively maintain stable positions aft, below and to either side of the LRP with aerodynamic forces being counteracted by the drag and tension on the two kite lines. Additional tension on any of these lines will cause the appropriate kite's orientation to change increasing the counteracting aerodynamic forces in order to maintain the kite's position relative to the LRP.

### Unmanned Aircraft System Launch

The UAS subject vehicle of this example is assumed to require clean airflow and significant clearance from the LRP for safe deployment. The subject vehicle is affixed to the trapeze line [FIG. 1-0103] with a releasable hook or other attachment device. This is performed while the subject vehicle is in the LRP. Using the trapeze line winches [FIG. 1-0102], the subject vehicle may be spooled from the LRP in a controlled fashion until the airflow meets required parameters at which time the attachment device is released through electronic, mechanical or other means and the subject vehicle is free to operate independently.

### Unmanned Aircraft System Recovery

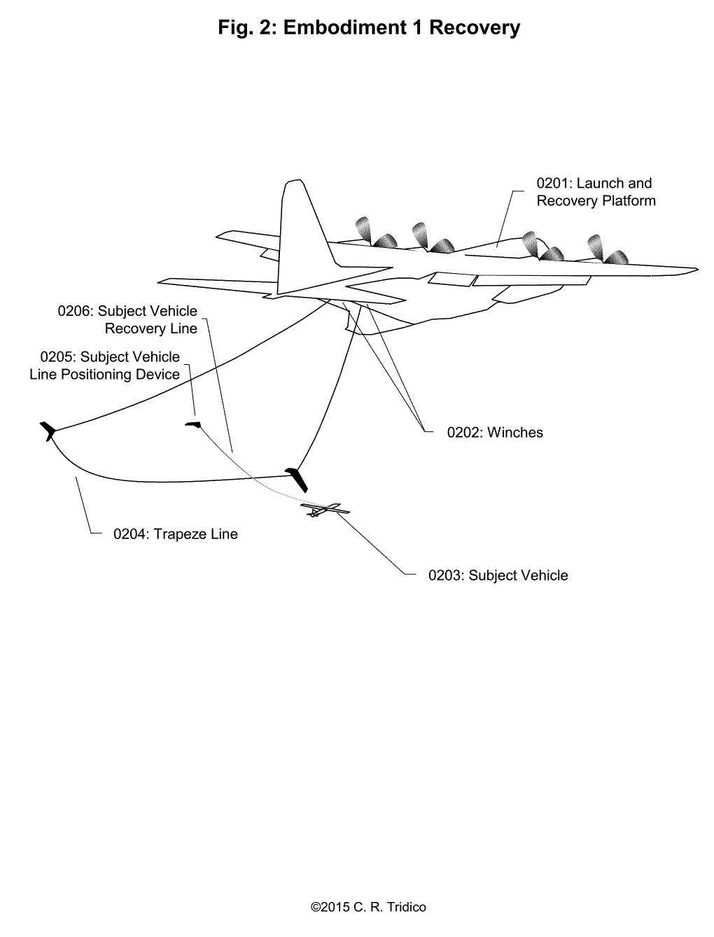

In the first exemplary embodiment of the present invention, any subject vehicle [FIG. 2-0203] requiring recovery by means of the proposed solution will be fitted with a small internal or flush mounted kite, line and spool assembly. The load points for this assembly are selected to minimize distance from the subject vehicle's centers of lift and thrust in order to minimize control input required to compensate for tension on the line. When recovery is initiated, the subject vehicle will release this recovery kite as a line positioning device [FIG. 2-0205] allowing the subject vehicle recovery line [FIG. 2-0206] to spool out a pre-determined distance above and aft of the subject vehicle. The recovery kite will maintain a stable position relative to the subject vehicle passively by means of aerodynamic forces. In this exemplary embodiment, the recovery kite is fitted with a closable hook affixed in such a way that any line crossing the recovery kite line and sliding along it to intercept the recovery kite will be trapped by the hook which will then close reactively in this exemplary embodiment.

Capture of the subject vehicle by the LRP is achieved by causing the recovery kite line of the subject vehicle to intersect the fully extended trapeze line [FIG. 2-0204] of the LRP and then spooling in the recovery kite winch as well as the trapeze winches [FIG. 2-0202]. Almost any relative velocity vectors which result in line intersection may be used as dictated by the performance characteristics of the subject vehicle and LRP [FIG. 2-0201].

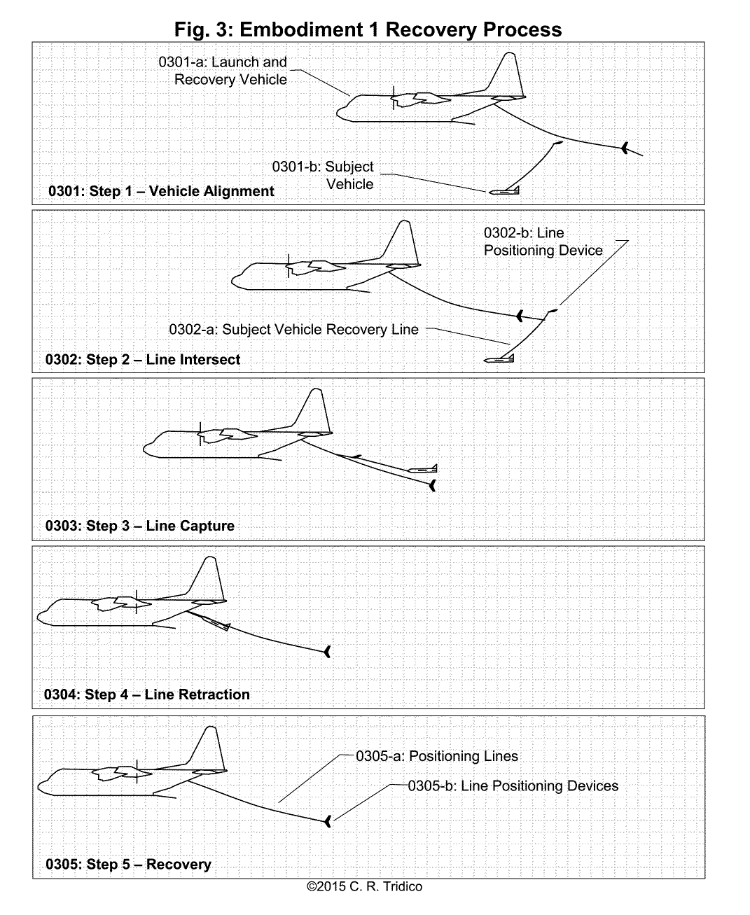

FIG. 3—“Embodiment 1 Recovery Process” provides a two dimensional side view of the recovery process. Step 1—Vehicle Alignment [FIG. 3-0301] illustrates the LRP [FIG. 3-0301-a] overtaking the subject vehicle [FIG. 3-0301-b]. Step 2—Line Intersect [FIG. 3-0302] illustrates the trapeze line of the LRP contacting the recovery line [FIG. 3-0302-a] that connects the subject vehicle with its kite [FIG. 3-0302-b Line Positioning Device]. In Step 3—Line Capture [FIG. 3-0303] the trapeze line is being retracted by the LRP's winches and has slid up the subject vehicle's recovery line to engage the hook on the line positioning device. In Step 4—Line Retraction [FIG. 3-0304] both the subject vehicle and LRP's winches have been mostly retracted, the subject vehicle is being partially supported by the connected trapeze line as it is no longer in a location where it can maintain stable flight. Step 5—Recovery [FIG. 3-0305] depicts the subject vehicle having been winched all the way into the LRP with the Positioning Lines [FIG. 3-0305-a] and Line Positioning Devices [FIG. 3-0305-b] remaining deployed for a future launch or recovery.

### Variations

The present invention may be mounted on or otherwise incorporated into a wide range of subject vehicles and launch and recovery platforms including those that operate on land, water or even in a vacuum.

Launch and recovery need not be performed from the same vehicle or site or even the same type of vehicle or site.

The subject vehicle and launch and recovery platform line positioning devices may be any device used to regulate the location, geometry or tension of the lines in the present invention. Some examples include weights, kites, balloons, streamers, parachutes, rockets or floats.

The subject vehicle may be of a differing type or may operate in a different environment from the launch and recovery platform. As one example, a surface ship may tow two kites supporting the launch and recovery line (trapeze) of the present invention in order to recover an unmanned aerial system fitted with the subject vehicle line of the present invention. In this variation, the subject vehicle line is fitted with a hook and a simple weight as the line positioning device. Following line capture, the launch and recovery platform line and subject vehicle line are both retracted at sufficient speed to maintain subject vehicle lift until the lines are retracted and recovery is complete.

The line positioning devices on both the subject vehicle and launch and recovery platform may be fitted with a combination of electromagnetic emitters and detectors in order to facilitate positioning, intercept and recovery.

### Advantages and Applicability

The present invention provides an alternative to prior art that is both novel and useful. The novel concept of a line mounted on the subject vehicle in conjunction with a line mounted on the launch and recovery platform provides a combination of features not found in prior art including the following examples:

The present invention enables retrofit or inclusion of the same general system on a wide range of subject vehicles and launch and recovery platforms enabling interoperability across different vehicles, application to different missions and use in varied environments.

The present invention provides a large intercept aperture relative to the size of the physical hardware required. This eases intercept during recovery and facilitates intercept of subject vehicles by LRPs with dramatically different performance characteristics from the subject vehicles. Furthermore, it avoids the mass, bulk and fluid dynamic impact of large nets, cranes, spars and similar components of relevant prior art.

Multiple aspects of the present invention assist in managing mechanical stresses on both the subject vehicle and LRP. For example, the relatively small size of the components of the present invention allow flexibility in the mounting and load bearing points allowing loads to be applied to structural components most able to handle them and with force vectors that have a minimal or beneficial impact of vehicle performance. Furthermore, the flexible and extendible/retractable nature of the intersecting lines of the present invention facilitates gradual transfer in loads and subsequent gradual change in the velocity of the subject vehicle further reducing mechanical stress on both the subject vehicle and LRP.

Taken collectively, the present invention provides a unique and beneficial approach to facilitate the launch and recovery of vehicles from a wide range of platforms. This enables subject vehicles to be deployed from platforms and to locations that may have been prohibited or difficult with prior art.

What is claimed is:

1. A system which is a Line Intersect Vehicle Launch and Recovery system, said system facilitating the launch and recovery of a subject vehicle by means of a wire, cable or other non-rigid line connected to said subject vehicle and a second line connected directly or indirectly to one or more vehicles or sites from which said subject vehicle is to be launched or recovered
wherein said subject vehicle is recovered by means of causing said lines to intersect and attach to each other by means of one or more hooks, carabiners or other attachment devices.

2. The system of claim 1 wherein the subject vehicle may be launched by releasing the attachment device of claim 1.

3. The system of claim 1 wherein the subject vehicle connected line is also connected to one or more weights, kites, balloons, streamers, parachutes, rockets or other devices used to regulate the location, geometry or tension of said line.

4. The system of claim 1 wherein the lines are used to alter the velocity vector of the subject vehicle.

5. The system of claim 1 wherein the subject vehicle connected line may be extended or retracted by means of a winch or similar spooling device.

6. The system of claim 1 wherein the site or vehicle connected line is connected to said site or vehicle by a means which allows the alteration of the location, geometry or tension of said line.

7. The system of claim 1 wherein said system's lines, vehicles, sites or devices are equipped with electromagnetic emitters and detectors in order to facilitate subject vehicle recovery.
